(19) United States
(12) Patent Application Publication
(10) Pub. No.: US 2013/0301530 A1
(43) Pub. Date: Nov. 14, 2013

(54) BASE STATION DEVICE

(71) Applicant: Sumitomo Electric Industries, Ltd., Osaka (JP)

(72) Inventor: Takashi YAMAMOTO, Osaka (JP)

(21) Appl. No.: 13/939,302

(22) Filed: Jul. 11, 2013

Related U.S. Application Data
(63) Continuation of application No. PCT/JP2011/073928, filed on Oct. 18, 2011.

(30) Foreign Application Priority Data
Jan. 14, 2011 (JP) 2011-005955

(51) Int. Cl. H04W 52/18

(52) U.S. Cl. CPC H04W 52/18
USPC 370/328

(57) ABSTRACT

Problems that may occur when the transmission power of a base station device is changed during communication between the base station device and a terminal device are prevented. A processing unit 3 of a base station device 1 executes: a power change process of changing the transmission power of a data signal to be transmitted by the base station device; a transmission process of transmitting, to the terminal device, a change request that requests the terminal device to change a power parameter indicating the magnitude of the transmission power; and a modulation scheme restriction process of prohibiting selection of quadrature amplitude modulation. The communication restriction process is executed during a time period in which there is a possibility that the magnitude of the transmission power in the base station device and the magnitude of the transmission power indicated by the power parameter of the terminal device may not be equivalent to each other.

### TECHNICAL FIELD

The present invention relates to a base station device.

### BACKGROUND ART

As digital modulation schemes, quadrature amplitude modulation (QAM) such as 16QAM or 64QAM as well as phase shift keying (PSK) modulation such as QPSK have been known.

In order to demodulate a signal modulated by the quadrature amplitude modulation such as 16QAM or 64QAM, amplitude information of the signal is needed in addition to phase information of the signal.

For example, in LTE (Long Term Evolution; refer to Non-Patent Literature 1), amplitude information required for demodulation of a signal modulated by 16QAM or 64QAM is defined by a ratio to a reference power. As an example of the reference power, the power of a reference signal (CRS: Cell-specific Reference Signal) is used.

Accordingly, by calculating a ratio of the power of an actually received data signal to the magnitude of an actually received reference signal, a terminal device can acquire the above-mentioned amplitude information of the signal to be demodulated.

### CITATION LIST

### Non Patent Literature

[NPL 1] Farooq Khan,“LTE for 4G Mobile Broadband: Air Interface Technologies and Performance”, Cambridge University Press, 2009

### SUMMARY OF THE INVENTION

### Problems to be Solved by the Invention

The inventors of the present invention have come up with an idea that it is desirable to change the magnitude of a transmission power of a base station device during communication between the base station device and a terminal device. By changing the magnitude of the transmission power in accordance with environmental change during the communication between the base station device and the terminal device, transmission at an appropriate transmission power is achieved.

However, if the base station device changes the magnitude of the transmission power during the communication with the terminal device, the following problems occur.

That is, it is difficult to match the timing at which the base station device changes the transmission power with the timing at which the terminal device responds to the change in the transmission power. Therefore, a time lag occurs between the timings. During this time lag, the transmission power grasped by the terminal device is different from the power actually transmitted by the base station device. As a result, the terminal device cannot acquire correct amplitude information, which makes it difficult for the terminal device to perform accurate demodulation.

As a result, the base station device needs to perform, for example, a process of retransmitting data that has failed to be transmitted, which obstructs smooth communication.

Therefore, an object of the present invention is to prevent the problems that may occur when the transmission power of the base station device is changed during the communication between the base station device and the terminal device.

### Solution to the Problems

(1) The present invention is a base station device that transmits a data signal modulated based on a modulation scheme selected from among a plurality of modulation schemes including phase shift keying modulation and quadrature amplitude modulation. The base station device includes a processing unit that executes: a power change process of changing a transmission power of the data signal to be transmitted from the base station device; a transmission process of transmitting, to a terminal device, a change request that requests the terminal device to change a power parameter indicating the magnitude of the transmission power; and a communication restriction process of prohibiting selection of the quadrature amplitude modulation as the modulation scheme so that phase shift keying modulation is performed, or suspending data transmission to the terminal device. The communication restriction process is executed during at least a part of a time period in which there is a possibility that the magnitude of the transmission power of the base station device and the magnitude of the transmission power indicated by the power parameter of the terminal device may not be equivalent to each other due to execution of the power change process or the transmission process.

According to the present invention, even if the magnitude of the transmission power of the base station device and the magnitude of the transmission power indicated by the power parameter of the terminal device may not be equivalent to each other, failure in data transmission can be reduced. That is, in the case where selection of the quadrature amplitude modulation as the modulation scheme is prohibited so that phase shift keying modulation is performed as the communication restriction process, amplitude information is not needed for demodulation, and therefore, the above-mentioned non-equivalence causes no problem. In addition, in the case where data transmission to the terminal device is suspended, since the data signal to be demodulated is not transmitted, failure in data transmission does not occur.

It is sufficient if the communication restriction process is executed during at least a part of a time period in which there is a possibility that the magnitude of the transmission power of the base station device and the magnitude of the transmission power indicated by the power parameter of the terminal device may not be equivalent to each other. However, it is preferable that the communication restriction process is executed during a time period including the entirety of the above-mentioned time period.

(2) Preferably, the communication restriction process is executed during at least a part of a time period from when the base station device transmits the change request to when the base station device receives a change notification indicating that the terminal device has changed the power parameter in response to the change request.

The terminal device changes the power parameter within a time period from the transmission of the change request to the reception of the change notification. Therefore, the time period from the transmission of the change request to the reception of the change notification is a time period in which there is a possibility that the magnitude of the transmission power of the base station device and the magnitude of the transmission power indicated by the power parameter of the terminal device may not be equivalent to each other.

(3) Preferably, the communication restriction process is started before the base station device transmits the change request. In this case, it is ensured advantageously that the communication restriction process has been executed in advance of the change of the power parameter by the terminal device.

(4) Preferably, the communication restriction process is ended after base station device has received a change notification indicating that the terminal device has changed the power parameter in response to the change request. In this case, it is ensured advantageously that the communication restriction process reliably continues until the terminal device changes the power parameter.

(5) Preferably, the power change process is executed during a time period from when the communication restriction process is started to when the communication restriction process is ended. In this case, it is ensured advantageously that the power change process by the base station device is performed during the communication restriction process.

(6) Preferably, the power change process is executed before the base station device transmits the change request. In this case, the power change process by the base station device is performed in a relatively early stage, which is advantageous when the transmission power needs to be changed as quickly as possible.

(7) Preferably, the power change process is executed after the base station device has received a change notification indicating that the terminal device has changed the power parameter in response to the change request. In this case, the base station device can perform the power change process after the terminal device has changed the power parameter.

(8) Preferably, the power change process is executed at a predetermined timing after the base station device has transmitted the change request, without determination as to whether the base station device has received a change notification indicating that the terminal device has changed the power parameter in response to the change request. In this case, it is possible to reduce a time lag between the timing at which the terminal device executes the power parameter change and the timing at which the base station device executes the power change process.

### BRIEF DESCRIPTION OF THE DRAWINGS

FIG. 1 is a diagram showing a base station device and terminal devices.

FIG. 2 is a configuration diagram of a base station device.

FIG. 3 is a diagram showing a layer structure for LTE.

FIG. 4 is a diagram showing resource blocks for LTE.

FIG. 5 is a diagram showing the magnitudes of powers of a reference signal, a control channel, and a PDSCH.

FIG. 6 Part (a) of FIG. 6 is a diagram describing QPSK, and part (b) of FIG. 6 is a diagram describing 16QAM.

FIG. 7 is a diagram showing transmission powers that vary among users.

Part (a) of FIG. 8 is a diagram showing an arrangement of terminals that causes interference, and part (b) of FIG. 8 is a diagram describing power conditioning for avoiding interference.

FIG. 9 is a first example of a power change sequence.

FIG. 10 is a second example of a power change sequence.

FIG. 11 is a third example of a power change sequence.

FIG. 12 is a fourth example of a power change sequence.

FIG. 13 is a fifth example of a power change sequence.

FIG. 14 is a sixth example of a power change sequence.

### DESCRIPTION OF EMBODIMENTS

Hereinafter, preferred embodiments of the present invention will be described with reference to the drawings.

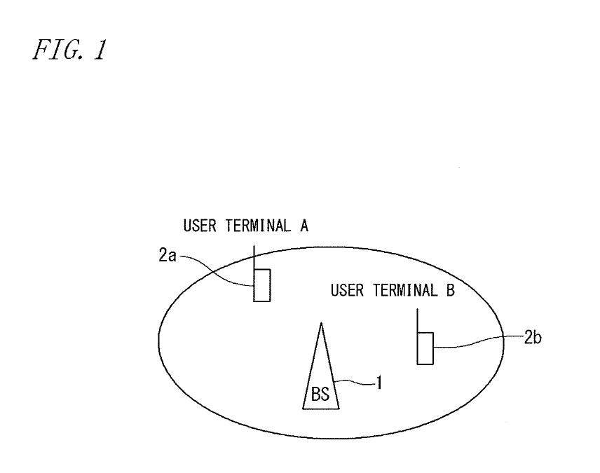

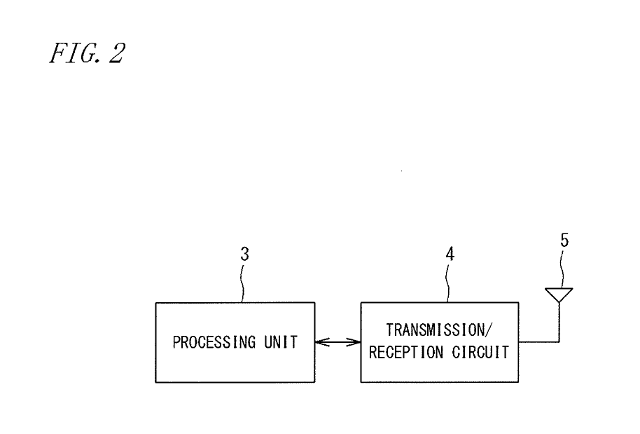

FIG. 1 shows a radio communication system including a base station device (BS; Base Station) 1, and terminal devices (MS; Mobile Station, or UE; User Equipment) 2a and 2b which are wirelessly connected to the base station device 1. The radio communication system of the present embodiment is, for example, a mobile phone system to which LTE is applied. In the radio communication system, communication based on LTE is performed between a plurality of base station devices 1 and the terminal device 2a, 2b. However, the communication scheme is not limited to LTE.

Examples of the base station device 1 provided in the radio communication system include: a macro base station device (Macro Base Station) that forms a communication area (macro cell) MC having a size of several kilometers; and a femto base station device (Femto Base Station) that is installed in a macro cell MC or the like and forms a relatively small femto cell FC having a size of several tens of meters. Although the following description will be made for, as a preferable example, a case where the base station device 1 is a femto base station device, the base station device 1 is not limited to the femto base station device.

As shown in FIG. 2, the base station device 1 includes a processing unit 3 and a transmission/reception circuit 4. The processing unit 3 performs digital modulation/demodulation on a signal transmitted/received in the transmission/reception circuit 4, communication control, and other processes relating to communication.

The transmission/reception circuit 4 performs analog signal processing (frequency conversion, amplification, and the like) on a transmission signal (baseband signal) outputted from the processing unit 3, and outputs the transmission signal from an antenna 5. Further, the transmission/reception circuit 4 performs analog signal processing on a reception signal received by the antenna 5, and supplies the reception signal to the processing unit 3.

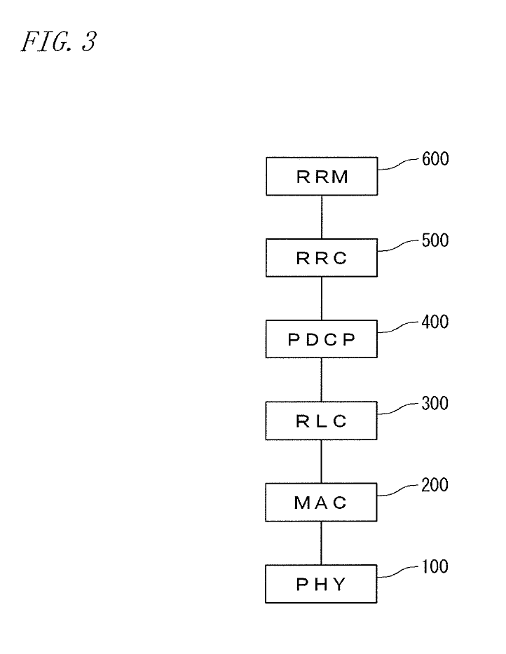

FIG. 3 shows a layer structure for LTE, relating to radio communication of the base station device 1. The layer structure shown in FIG. 3 includes a PHY (Physical Layer) 100 as a first layer relating to radio communication, and a MAC 200 as a layer higher in order than the PHY 100. An RLC (Radio Link Control) 300 and a PDCP (Packet Data Convergence Protocol) 400 are arranged as layers higher in order than the MAC 200. Further, an RRC (Radio Resource Control) 500 and an RRM (Radio Resource Management) 600 are arranged as layers higher in order than the PDCP. The processing unit 3 is configured to perform processes for these layers.

It is noted that the terminal device 2a, 2b has a layer structure identical to that of the base station device 1.

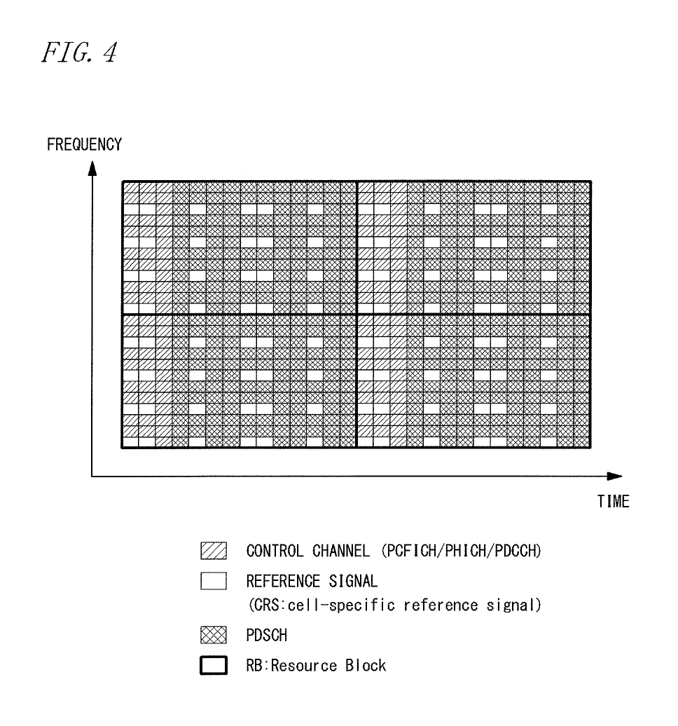

FIG. 4 shows a resource block (RB) structure for LTE, constituting a transmission frame (downlink frame) of the base station device 1. A resource block is a minimum unit for resource allocation to a terminal device (user). The downlink frame is constituted by a plurality of resource blocks arranged in the frequency direction and in the time direction, respectively. Each terminal device (user) is assigned one resource block or a combination of a plurality of resource blocks. Thus, one frame can be shared by a plurality of users.

One resource block is constituted by a plurality of resource elements arranged in the frequency axis direction and in the time axis direction, respectively. In FIG. 4, three symbols at the beginning of each resource block are secured as a control channel (PCFICH/PHICH/PDCCH), and the remaining symbols correspond to a physical downlink shared channel (PDSCH).

A control channel such as PDCCH is used for notification of control information (L1/L2 control information) such as resource block allocation information, to a terminal device. The PDSCH is used for transmission of a downlink data signal.

It is noted that reference signals (CRS) are discretely arranged in the resource blocks.

Each terminal device (user) 2a, 2b is assigned the PDSCH in units of resource blocks. Demodulation of a data signal included in the PDSCH is performed by using a reference signal that is common to all terminal devices.

In LTE, a modulation scheme for the control channel is QPSK. On the other hand, a modulation scheme for the PDSCH is selected from among three modulation schemes, QPSK, 16QAM, and 64QAM, depending on the channel environment and the like.

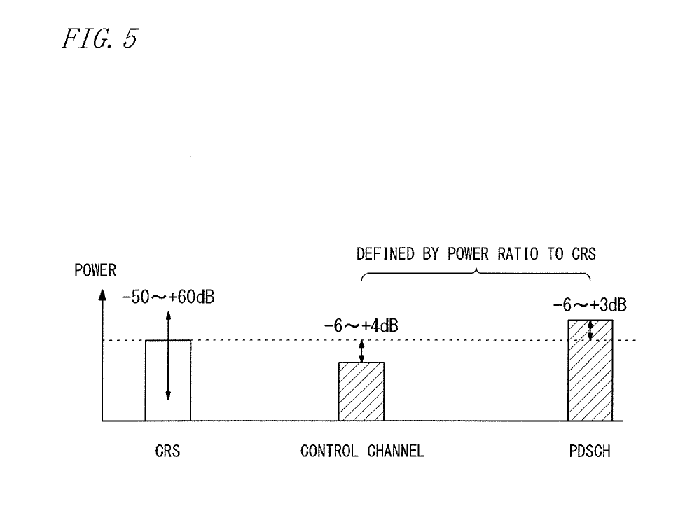

FIG. 5 shows the magnitudes of powers of the different types of downlink signals transmitted from the base station device 1. The magnitude of the transmission power of the reference signal (CRS) is in a range of −50 dBm to +60 dBm, and this value is common to all terminal devices. The magnitude of the transmission power of the reference signal is notified to the terminal device 2a, 2b by using SIB2 (System Information Block 2) in the PDSCH.

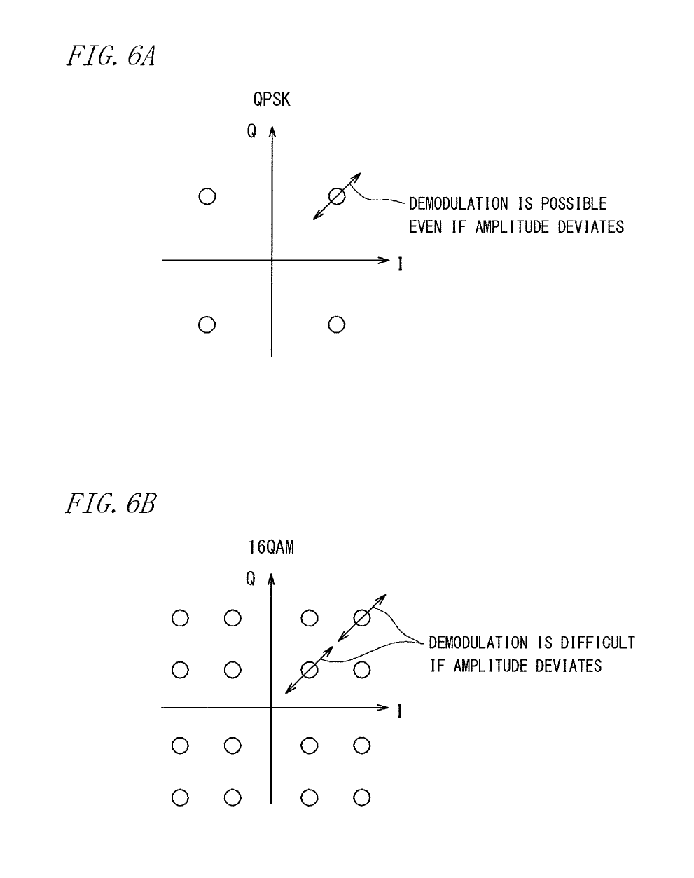

The magnitude of the transmission power of the control channel is defined by a power ratio to the reference signal, and is in a range of −6 dB to +4 dB with respect to the transmission power of the reference signal. The magnitude of the transmission power of the control channel is variable in each terminal device. However, since the modulation scheme for the control channel is QPSK, each terminal device need not grasp the magnitude of the transmission power. That is, as shown in FIG. 6(a), in order to demodulate a signal modulated by QPSK, phase information of the signal suffices, and amplitude information thereof is not needed. Accordingly, the magnitude of the transmission power of the control channel is not notified from the base station device 1 to the terminal device 2a, 2b.

The magnitude of the transmission power of the PDSCH is also defined by a power ratio to the reference signal, and is in a range of −6 dB to +3 dB with respect to the transmission power of the reference signal. The magnitude of the transmission power of the PDSCH is variable in each terminal device. Since the modulation schemes for the PDSCH include 16QAM and 64QAM as quadrature amplitude modulation as well as QPSK as phase shift keying modulation, the base station device 1 needs to notify the terminal device 2a, 2b of the transmission power of the PDSCH.

That is, as shown in FIG. 6(b), in the quadrature amplitude modulation such as 16QAM, signal amplitude information (the magnitude of amplitude) is needed in addition to signal phase information.

Therefore, the terminal device 2a, 2b calculates, as amplitude information, the relative magnitude (power ratio) of the reception power of the PDSCH, based on the magnitude of the reception power of the reference signal. Then, each terminal device performs demodulation, taking into account the magnitude of the transmission power of the PDSCH.

The absolute magnitude of the reception power of the PDSCH is influenced by the magnitude of the transmission power of the PDSCH, and the channel environment, and therefore, is not suitable as amplitude information. By calculating the amplitude information of the PDSCH as a reception power ratio to the reference signal as described above, the influence due to the channel environment can be canceled. However, even at the same signal point in QAM, the magnitude of amplitude indicating the signal point varies if the magnitude of the transmission power of the PDSCH varies. Therefore, by taking into account the magnitude of the transmission power of the PDSCH, demodulation can be performed appropriately even when the magnitude of the transmission power of the PDSCH varies.

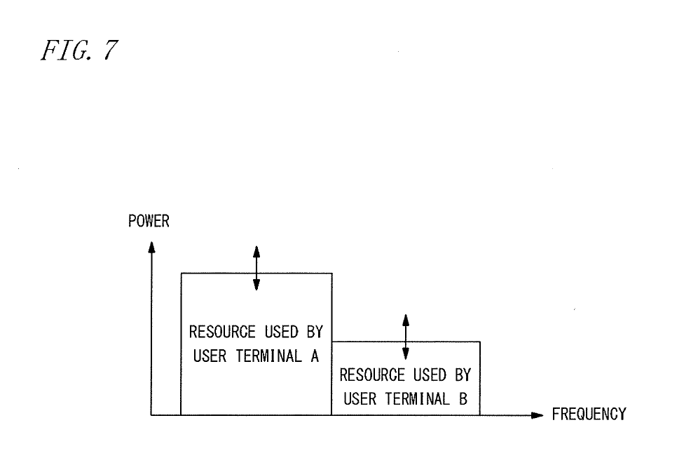

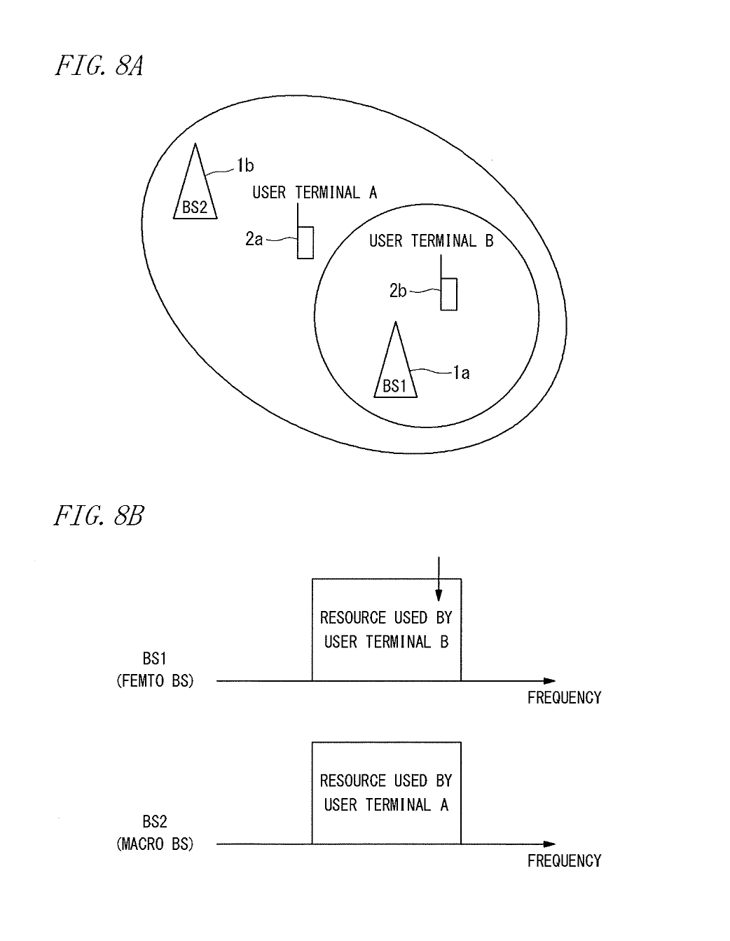

As an example of the case where it is desirable to vary the transmission power for each terminal device 2a, 2b as shown in FIG. 7, a case is considered where the distance from the base station device 1 to the user terminal A is different from the distance from the base station device 1 to the user terminal B as shown in FIG. 1. In FIG. 1, since the user terminal A is more distant from the base station device 1 than the user terminal B, it is desirable to make the transmission power of the user terminal A greater than that of the user terminal B as shown in FIG. 7.

Further, as shown in FIG. 8(a), in a case where a femto base station device 1a is located in a macro cell farmed by a macro base station device 1b, if a user terminal 2b connected to the femto base station device 1a and a user terminal 2a connected to the macro base station device 1b use resource blocks of the same frequency for downlinking, a downlink signal from the femto base station device 1a might be an interference signal to the user terminal 2a.

In this case, as shown in FIG. 8(b), the femto base station device 1a can prevent such interference to the user terminal 2a by reducing the power of the frequency resource for which the femto base station device 1a conflicts with another cell.

In the case where the base station device 1 changes the transmission power of the PDSCH for each terminal device, the terminal device 2a, 2b needs to grasp the magnitude (the power ratio to the reference signal) of the changed transmission power in order to accurately perform demodulation.

The base station device 1 has a power parameter indicating the magnitude of the transmission power (the power ratio to the reference signal) for each terminal device. When changing the transmission power, the base station device 1 changes the power parameter. On the other hand, the terminal device 2a, 2b also has a power parameter indicating the magnitude of the transmission power from the base station device 1 to the terminal device. By referring to its own power parameter, the terminal device 2a, 2b can take into account the transmission power of the base station device 1 at the time of signal demodulation of the PDSCH.

Accordingly, when the base station device 1 changes its own power parameter in order to change the transmission power of the PDSCH, the value of the power parameter of the terminal device 2a, 2b needs to be changed. Therefore, the base station device 1 that attempts to change the transmission power transmits a power change request to a terminal device for which the transmission power is to be changed, and thus the value of the power parameter of the terminal device can be equivalent to the value of the power parameter of the base station device.

In LTE, however, it is not assumed that the base station device 1 performs transmission power control to change the transmission power of the PDSCH during communication. In LTE, the base station device 1 deals with a distant terminal device 2 not by increasing the transmission power but by changing the modulation scheme or the coding rate. In LTE, by performing no transmission power control, frequent transmission of power information to the terminal device 2 can be avoided.

On the other hand, when the base station device 1 attempts to change the transmission power as described above, the timing to change the transmission power might be during communication in which connection between the base station device 1 and the terminal device 2a, 2b has been established.

In LTE, the transmission power of the reference signal is frequently notified by using SIB2, whereas notification of the transmission power of the PDSCH is performed by using RRC Connection Setup/Reconfiguration. In the present embodiment, the RRC Connection Setup/Reconfiguration is used as a power change request. However, since the RRC Connection Setup/Reconfiguration is a message in an RCC layer, it takes time to exchange the message as compared to the notification using SIB2.

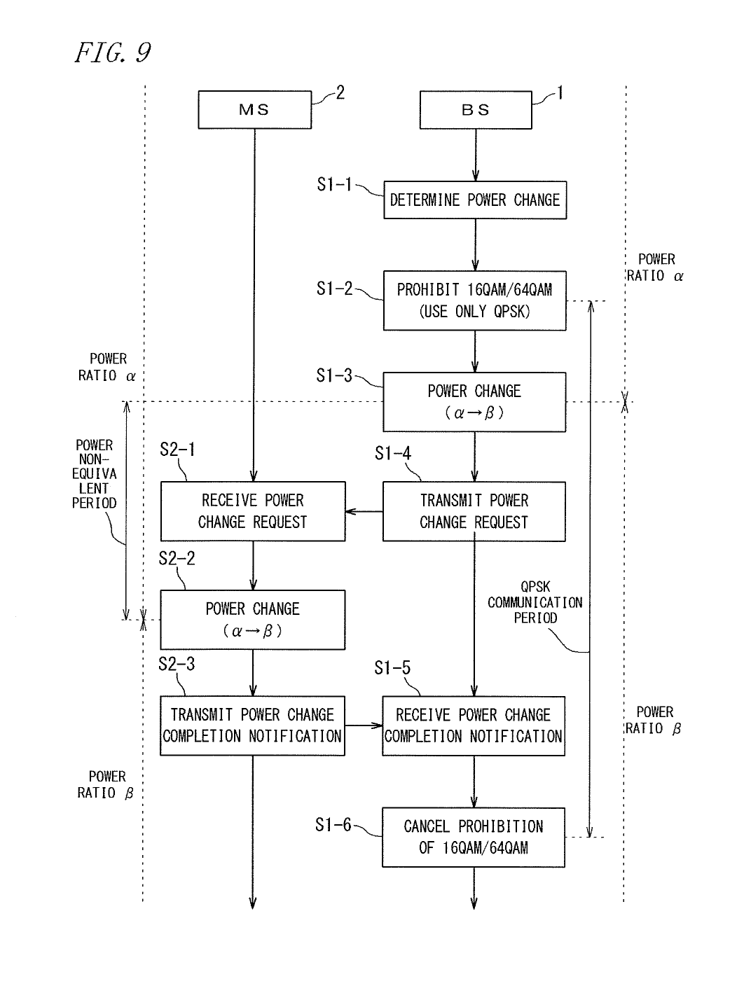

FIGS. 9 to 14 each show a power change process sequence in a case where, during communication between the base station device 1 and the terminal device 2, the base station device 1 has determined that the transmission power of the PDSCH should be changed (step S1-1).

In a first example of a power change process sequence shown in FIG. 9, when the processing unit 3 has determined to change the transmission power (step S1-1), the processing unit 3 executes a modulation scheme restriction process (communication restriction process) which prohibits 16QAM and 64QAM each being quadrature amplitude modulation that requires amplitude information for demodulation from being selected, among the three selectable modulation schemes, i.e., QPSK, 16QAM, and 64QAM (step S1-2). After the modulation scheme restriction process has been started, 16QAM and 64QAM are prohibited from being selected as a modulation scheme until completion of this process, and downlink communication is performed by using QPSK. It is noted that the modulation scheme selected by the base station device is notified every msec to the terminal device 2 by the control channel.

Subsequently, the processing unit 3 performs a power change process to change the power parameter of the base station device 1, in order to change the transmission power of the data signal of the PDSCH transmitted by the base station device 1(step S1-3). In the following, the value of the power parameter (the power ratio to the reference signal) before the power change process is α, and the value of the power parameter after the power change process is β.

In the base station device 1, when the power change process is executed, the value of the power parameter is changed from α to β, and thereby the transmission power of the PDSCH is changed. However, at the time of step S1-3, the power parameter of the terminal device 2 remains at α. That is, the magnitude of the transmission power of the PDSCH in the base station device 1 is not equivalent to the magnitude of the transmission power indicated by the power parameter of the terminal device 2.

However, in the modulation scheme restriction process previously performed, the modulation scheme has been restricted to the modulation scheme (QPSK) that does not require amplitude information for demodulation. Therefore, the non-equivalence between the magnitude of the transmission power of the PDSCH in the base station device 1 and the magnitude of the transmission power indicated by the power parameter of the terminal device 2 does not affect demodulation in the terminal device 2. If modulation is performed by 16QAM or 64QAM during the power non-equivalence period, it is difficult for the terminal device 2 to perform accurate demodulation. However, by including the entirety of the power non-equivalence period in the QPSK communication period as shown in FIG. 9, demodulation is enabled.

Further, the processing unit 3 generates a power change request that requests the terminal device 2 to change, from α to β, the power parameter indicating the magnitude of the transmission power of the PDSCH. Then, the processing unit 3 performs a transmission process to transmit the power change request to the terminal device 2 (step S1-4). Upon receiving the power change request (step S2-1), the terminal device 2 changes the power parameter of the terminal device 2 from α to β (step S2-2). Thereby, the magnitude of the transmission power of the PDSCH in the base station device 1 is equivalent to the magnitude of the transmission power indicated by the power parameter of the terminal device 2.

Thereafter, the terminal device 2 transmits, to the base station device 1, power change completion notification (change notification) as a response to the power change request (step S2-3). When the base station device 1 has received the power change completion notification (step S1-5), the processing unit 3 of the base station device 1 grasps that the terminal device 2 has changed the power parameter. In the LTE standard, it is only prescribed that the terminal device 2 must transmits the power change completion notification to the base station device 1 within 15 msec after reception of the power change request. Therefore, it takes a certain amount of time until the base station device 1 receives the power change completion notification.

Upon determining that the power change completion notification has been received, the processing unit 3 ends the modulation scheme restriction process to cancel the selection prohibition of 16QAM and 64QAM (step S1-6).

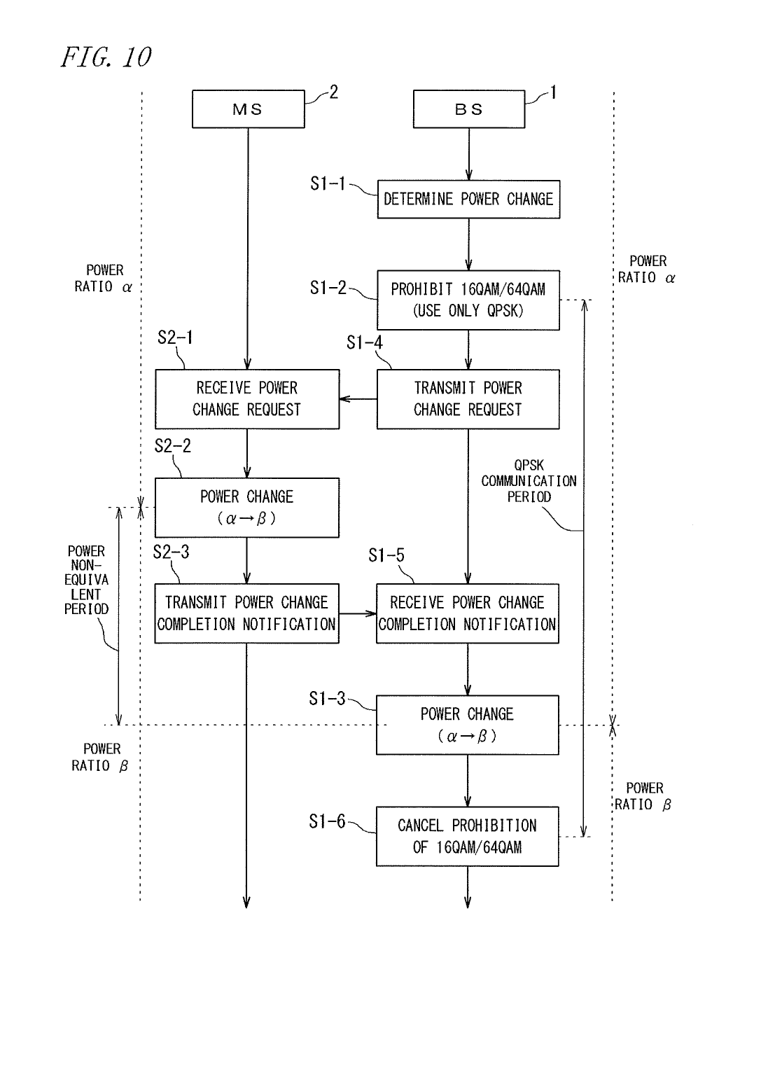

A second example of a power change process sequence shown in FIG. 10 is different from the sequence shown in FIG. 9 in that the power change process (S1-3) is performed after the reception of the power change completion notification (S1-5). Also in the case of the sequence shown in FIG. 10, since the entirety of the power non-equivalence period is included in the QPSK communication period, demodulation is enabled. In the sequence of FIG. 10, for those points that are not described, the matters described with reference to FIG. 9 are incorporated.

In the sequence of FIG. 9, in a relatively early stage (before transmission of the power change request) after the power change determination (S1-1), the transmission power is changed in the base station device 1. Therefore, as compared to the sequence of FIG. 10, the sequence of FIG. 9 is advantageous for the case where the transmission power is desired to be changed as quickly as possible. For example, in the case where the transmission power should be reduced in order to avoid interference to a terminal device in another cell, since the transmission power should be reduced as quickly as possible, the sequence of FIG. 9 is advantageous.

On the other hand, the sequence of FIG. 10 is advantageous in that the transmission power of the base station device 1 can be changed after the power parameter of the terminal device 2 has been changed. For example, even if the base station device 1 has transmitted a power change request to a certain terminal device 2, the terminal device 2 may fail to receive the power change request, and thus the base station device 1 cannot receive a power change completion notification. In the sequence of FIG. 9, if the base station device 1 cannot receive a power change completion notification, the power changed to β in step S1-3 needs to be restored to α. On the other hand, in the sequence of FIG. 10, since the base station device 1 changes the power after confirming reception of a power change completion notification, the process of restoring the power is not needed, and therefore, the sequence of FIG. 10 is advantageous.

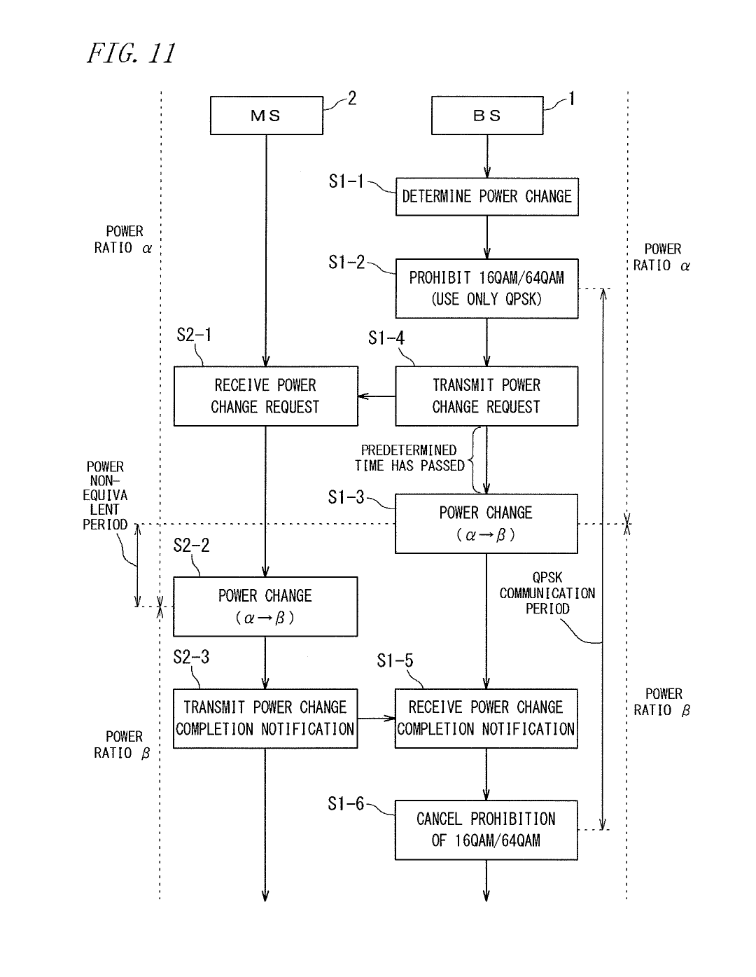

FIG. 11 shows a third example of a power change process sequence. In the sequence of FIG. 11, the power change process (S1-3) is performed at a predetermining timing after the base station device 1 has transmitted a power change request, without determination as to whether a power change notification has been received. The timing to perform the power change process may be a timing (e.g., a time point after a lapse of 5 msec from the transmission of the power change request) within a time period (15 msec after the transmission of the power change request) that is set as a stand-by period for reception of a power change completion notification after the transmission of the power change request (S1-4). In the sequence of FIG. 11, for those points that are not described, the matters described with reference to FIG. 9 are incorporated.

The sequence of FIG. 11 is advantageous in that the power non-equivalence period between the base station device 1 and the terminal device 2 can be reduced.

In FIGS. 9 to 11, QAM is prohibited over the entirety of the power non-equivalence period between the base station device 1 and the terminal device 2. However, QAM may be prohibited in a part of the power non-equivalence period. For example, start of the modulation scheme restriction process (S1-2) may be performed not before the transmission of the power change request (S1-4) but after the transmission of the power change request (S1-4). In addition, end of the modulation scheme restriction process (S1-6) may be performed without determination as to whether a power change notification has been received.

By prohibiting QAM in at least a part of the power non-equivalence period, demodulation is prevented from being disabled in the period in which QAM is prohibited.

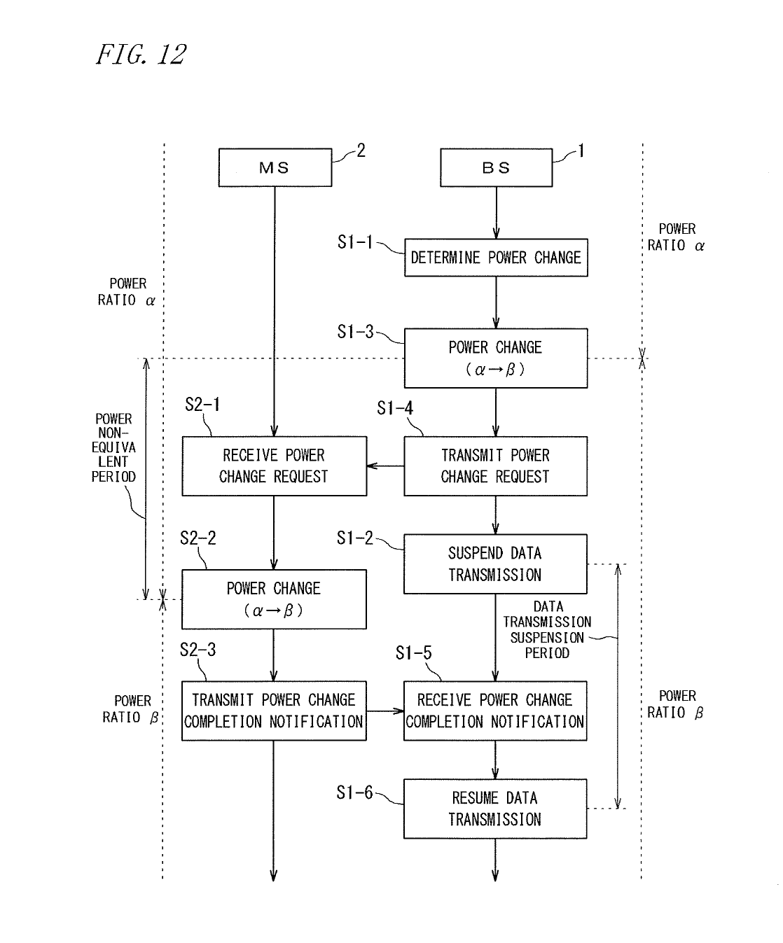

FIG. 12 shows a fourth example of a power change process sequence. In the sequence of FIG. 12, instead of the start (S1-2) and end (S1-6) of the modulation scheme restriction process in the sequence of FIG. 9, start (S1-2) of a data transmission signal suspension process (communication restriction process) is performed after the transmission of the power change request (S1-4), and end (S1-6) of the data transmission signal suspension process is performed after the reception of the power change completion notification (S1-5). In the sequence of FIG. 12, for those points that are not described, the matters described with reference to FIG. 9 are incorporated.

When the suspension process is performed, transmission to the terminal device 2 using DTCH (Dedicated Traffic CHannel), which is data transmission specific to each user in a logical channel, is suspended while connection between the base station device 1 and the terminal device 2 remains to be established. That is, while the suspension process is being executed, the terminal device 2 has no data signal to receive. As a result, the terminal device 2 has no data signal to demodulate, and thus occurrence of a data retransmission process due to failure in demodulation can be avoided.

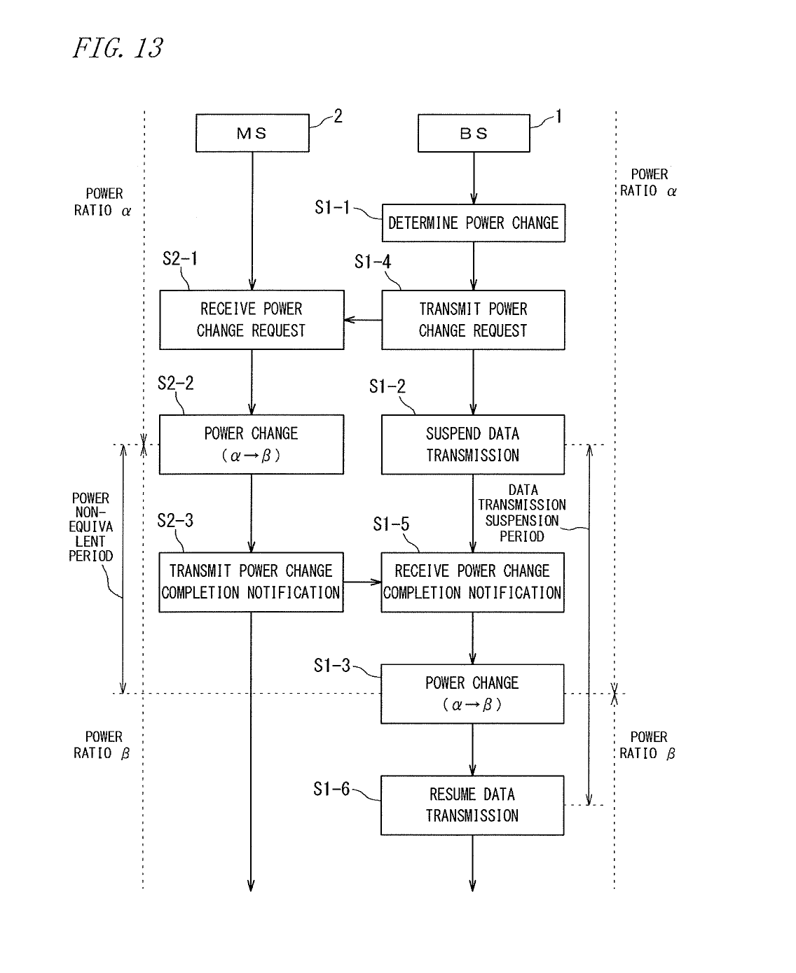

FIG. 13 shows a fifth example of a power change process sequence. In the sequence of FIG. 13, although the suspension process as the communication restriction process is executed like in the sequence of FIG. 12, the power change process (S1-3) is executed after the power change completion notification has been received, like in the sequence of FIG. 10. Also in the sequence of FIG. 13, occurrence of a data retransmission process due to failure in demodulation can be avoided, and the same effect as that achieved in the sequence of the FIG. 10 can be achieved.

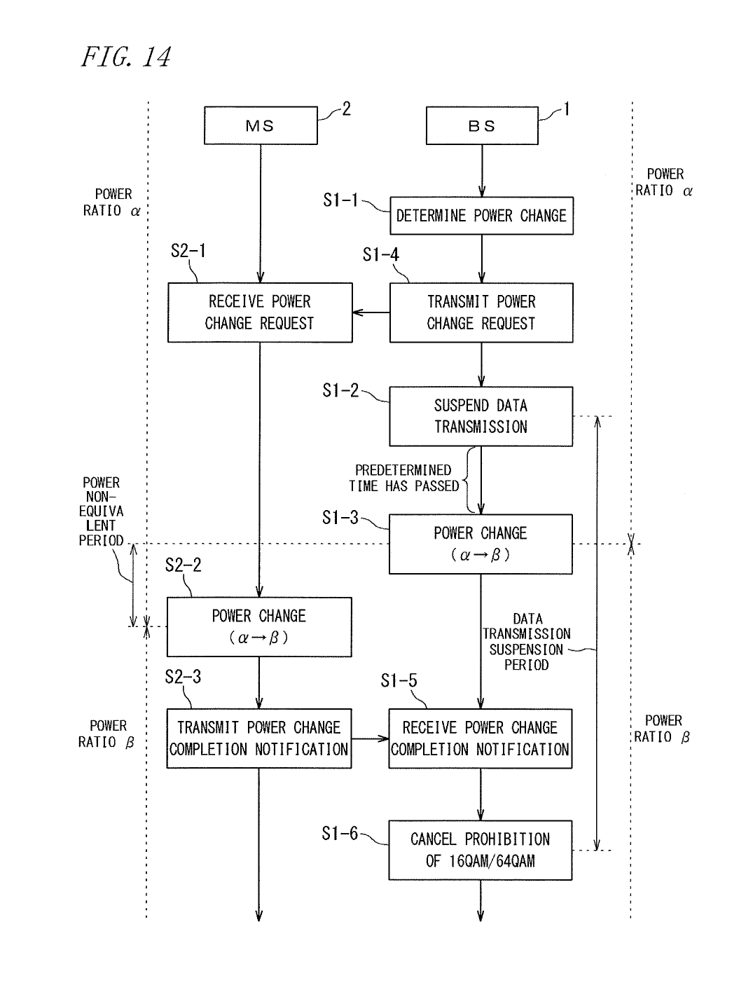

FIG. 14 shows a sixth example of a power change process sequence. In the sequence of FIG. 14, although the suspension process as the communication restriction process is executed like in the sequence of FIG. 12, the power change process (S1-3) is executed at a predetermined timing after the base station device 1 has transmitted the power change request or at a predetermined timing after start of the suspension process, without determination as to whether a power change notification has been received, like in the sequence of FIG. 11. Also in the sequence of FIG. 14, occurrence of a data retransmission process due to failure in demodulation can be avoided, and the same effect as that achieved in the sequence of the FIG. 11 can be achieved.

The embodiment described above is to be considered in all respects as illustrative and not restrictive. The scope of the present invention is indicated by the appended claims rather than by the foregoing meaning, and all changes which come within the meaning and range of equivalency of the claims are therefore intended to be embraced therein.

For example the communication standard is not limited to LTE, and other communication standards may be adopted.

Further, phase shift keying (PSK) modulation is not limited QPSK, and BPSK or 8PSK may be used. Further, quadrature amplitude modulation (QAM) may be 128QAM or 256QAM.

### DESCRIPTION OF THE REFERENCE CHARACTERS

1 base station device
2a terminal device
2b terminal device
3 processing unit
4 transmission/reception circuit
5 antenna

1. A base station device that transmits a data signal modulated based on a modulation scheme selected from among a plurality of modulation schemes including phase shift keying modulation and quadrature amplitude modulation, the base station device comprising:
a processing unit that executes
a power change process of changing a transmission power of the data signal to be transmitted from the base station device,
a transmission process of transmitting, to a terminal device, a change request that requests the terminal device to change a power parameter indicating the magnitude of the transmission power, and
a communication restriction process of prohibiting selection of the quadrature amplitude modulation as the modulation scheme so that phase shift keying modulation is performed, or suspending data transmission to the terminal device, wherein
the communication restriction process is executed during at least a part of a time period in which there is a possibility that the magnitude of the transmission power of the base station device and the magnitude of the transmission power indicated by the power parameter of the terminal device may not be equivalent to each other due to execution of the power change process or the transmission process.

2. The base station device according to claim 1, wherein
the communication restriction process is executed during at least a part of a time period from when the base station device transmits the change request to when the base station device receives a change notification indicating that the terminal device has changed the power parameter in response to the change request.

3. The base station device according to claim 1, wherein
the communication restriction process is started before the base station device transmits the change request.

4. The base station device according to claim 1, wherein
the communication restriction process is ended after the base station device has received a change notification indicating that the terminal device has changed the power parameter in response to the change request.

5. The base station device according to claim 1, wherein
the power change process is executed during a time period from when the communication restriction process is started to when the communication restriction process is ended.

6. The base station device according to claim 5, wherein
the power change process is executed before the base station device transmits the change request.

7. The base station device according to claim 5, wherein
the power change process is executed after the base station device has received a change notification indicating that the terminal device has changed the power parameter in response to the change request.

8. The base station device according to claim 5, wherein
the power change process is executed at a predetermined timing after the base station device has transmitted the change request, without determination as to whether the base station device has received a change notification indicating that the terminal device has changed the power parameter in response to the change request.
